(19) United States
(12) Patent Application Publication
(10) Pub. No.: US 2025/0008474 A1
(43) Pub. Date: Jan. 2, 2025

(54) METHOD AND APPARATUS FOR PROCESSING OF POSITIONING REFERENCE SIGNAL PRS PROCESSING WINDOW

(71) Applicant: SAMSUNG ELECTRONICS CO., LTD., Suwon-si, Gyeonggi-do (KR)

(72) Inventors: Pengru LI, Beijing (CN); Qi XIONG, Beijing (CN); Feifei SUN, Beijing (CN)

(21) Appl. No.: 18/707,546

(22) PCT Filed: Nov. 3, 2022
(86) PCT No.: PCT/KR2022/017162

§ 371 Date: May 3, 2024

(30) Foreign Application Priority Data
Nov. 3, 2021 (CN) 202111296499.1
Dec. 9, 2021 (CN) 202111501441.6
Feb. 28, 2022 (CN) 202210191560.4

(51) Int. Cl. H04W 64/00; H04L 5/00; H04W 8/22; H04W 24/10

(52) U.S. Cl. CPC H04W 64/00; H04L 5/0051; H04W 8/22; H04W 24/10

(57) ABSTRACT

The disclosure relates to a 5G or 6G communication system for supporting a higher data transmission rate. The application provides a method for positioning performed by a user equipment in a wireless communication system, comprising: determining window configuration information, wherein the window configuration information is used for configuring resources of the window; measuring the signal for positioning in the window, according to the window configuration information; and reporting the measurement result.

### TECHNICAL FIELD

The invention relates to a method and apparatus for processing of positioning reference signal (PRS) processing window in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

This disclosure relates to scheduling for processing of positioning reference signal (PRS) processing window in a wireless communication system.

In one embodiment, a method for a UE is provided. The method includes determining window configuration information includes at least one of the following: through at least one of the downlink control information (DCI) signalling, the radio resource control (RRC) signalling, the downlink media access control element (DL MAC CE) signalling, the new wireless (NR) positioning protocol A (NRPPa) message and the long term evolution (LTE) positioning protocol (LPP) message, the user equipment receives window configuration information configured by a base station which is indicated by the higher layer functional entity and/or window configuration information configured directly by a higher layer functional entity; receives window configuration information from the base station through at least one of the DCI signalling, the RRC signalling, the DL MAC CE signalling, the NRPPa message and the LPP message; and the user equipment determines the window configuration information by itself, and reports the window configuration information to the base station and/or higher layer functional entity through at least one of the uplink control information (UCI) signalling, the RRC signalling, the uplink MAC control element (UL MAC CE) signalling, the NRPPa message and the LPP message.

### Advantageous Effects of Invention

According to the embodiments of the present invention, processing of positioning reference signal (PRS) processing window in a wireless communication system.

### BRIEF DESCRIPTION OF DRAWINGS

FIG. 1 shows a schematic diagram of an example wireless network 100 according to various embodiments of the present disclosure;

FIGS. 2A and 2B show schematic diagrams of example wireless transmission and reception paths according to the present disclosure;

FIG. 3A shows a schematic diagram of an example UE 116 according to the present disclosure;

FIG. 3B shows a schematic diagram of an example gNB 102 according to the present disclosure;

FIG. 4 shows a schematic diagram of a reception measurement method of a downlink positioning reference signal PRS based on a positioning reference signal PRS processing window according to an embodiment of the present invention;

FIG. 5 illustrates a structure of a UE according to an embodiment of the disclosure; and

FIG. 6 illustrates a structure of a base station according to an embodiment of the disclosure.

### BEST MODE FOR CARRYING OUT THE INVENTION

According to one aspect of the present invention, there is provided a method for positioning performed by a user equipment in a wireless communication system, comprising: determining window configuration information, wherein the window configuration information is used for configuring resources of the window; measuring the signal for positioning in the window, according to the window configuration information; and reporting the measurement result.

In another aspect of the present invention, there is provided a method for positioning performed by the user equipment in a wireless communication system, wherein determining window configuration information includes at least one of the following: through at least one of the downlink control information (DCI) signalling, the radio resource control (RRC) signalling, the downlink media access control element (DL MAC CE) signalling, the new wireless (NR) positioning protocol A (NRPPa) message and the long term evolution (LTE) positioning protocol (LPP) message, the user equipment receives window configuration information configured by a base station which is indicated by the higher layer functional entity and/or window configuration information configured directly by a higher layer functional entity; receives window configuration information from the base station through at least one of the DCI signalling, the RRC signalling, the DL MAC CE signalling, the NRPPa message and the LPP message; and the user equipment determines the window configuration information by itself, and reports the window configuration information to the base station and/or higher layer functional entity through at least one of the uplink control information (UCI) signalling, the RRC signalling, the uplink MAC control element (UL MAC CE) signalling, the NRPPa message and the LPP message.

In another aspect of the present invention, there is provided a method for positioning performed by the user equipment in a wireless communication system, wherein the signal for positioning include at least one of the positioning reference signal (PRS), the synchronization signal block (SSB), the channel state information reference signal (CSI-RS), the tracking reference signal (TRS), the SSB for positioning, the CSI-RS for positioning and the TRS for positioning.

In another aspect of the present invention, there is provided a method for positioning performed by the user equipment in a wireless communication system, wherein the window configuration information includes at least one of the following: information related with the bandwidth of the window, information related with the period of the window, information related with the starting point of period of the window, information related with the duration of the window, and information related with the starting point of the window.

In another aspect of the present invention, there is provided a method for positioning performed by the user equipment in a wireless communication system, further comprising: determining the priority of the signal for positioning and other downlink signals/channels in the time unit within the window or in the time unit where the transmitted signal for positioning overlaps with other downlink signals/channels.

In another aspect of the present invention, there is provided a method for positioning performed by the user equipment in a wireless communication system, further comprising: determining the priority of the signal for positioning and other downlink signals/channels by measuring the signal for positioning in the window and/or receiving an indication of the priority for positioning.

In another aspect of the present invention, there is provided a method for positioning executed by the user equipment in a wireless communication system, further comprising: the user equipment transmits the processing capability of signal for positioning in the user equipment to a base station or a higher layer functional entity.

In another aspect of the present invention, there is provided a method for positioning executed by the user equipment in a wireless communication system, wherein the user equipment transmitting the processing capability of signal for positioning in the user equipment to a base station or a higher layer functional entity comprises: the user equipment reports indication information to the base station equipment and/or the higher layer functional entity, wherein the indication information is used to indicate whether the signal for positioning or other downlink signals/channels can be received at the same time in a time unit within the window; or the user equipment informs the base station equipment and/or higher layer functional entity whether to receive other downlink signals in the window through at least one of the UCI signalling, the RRC signalling and the MAC CE signalling.

In another aspect of the present invention, there is provided a method for positioning performed by the user equipment in a wireless communication system, further comprising receiving the signal for positioning and/or a first downlink signal according to the priority information.

In another aspect of the present invention, there is provided a method for positioning performed by the user equipment in a wireless communication system, wherein determining the priority of signal for positioning and other downlink signals/channels includes determining the priority by implied and/or indicated by a base station.

In another aspect of the present invention, there is provided a method for positioning performed by the user equipment in a wireless communication system, wherein determining the priority of signal for positioning and other downlink signals/channels includes one or more of the following: determining the priority of signal for positioning and other downlink signals/channels by obtaining the priority options and/or state indications through an implied mode, through the RRC signallings, through the DCI signallings and/or through the MAC CE signallings.

In another aspect of the present invention, there is provided a method for positioning performed by the user equipment in a wireless communication system, wherein the obtained priority options and/or priority state indications include one or more of the following: a 2-bit RRC signalling indicating the priority of the signal for positioning; a 1 bit RRC signalling or a 1 bit DCI signalling or a 1 bit MAC CE signalling indicating the priority of the signal for positioning; and/or a 1 bit RRC signalling and/or a 1 bit DCI and/or a 1 bit MAC CE indicating the priority of the signal for positioning.

In another aspect of the present invention, there is provided a method for positioning performed by the user equipment in a wireless communication system, further comprising: using the determined priority of the signal for positioning and other downlink signals/channels within a specific window of the signal for positioning.

In another aspect of the present invention, there is provided a method for positioning performed by the user equipment in a wireless communication system, wherein the specific window of the signal for positioning includes: a first window of the signal for positioning after N+X time and/or a window of the signal for positioning overlapping/colliding with other downlink signals or downlink channels after N+X time, wherein N is the end position of PDCCH corresponding to the DCI, and/or the end position of PDSCH containing the RRC signalling or the MAC CE, and/or the end position of PDCCH corresponding to the PDSCH, wherein X is the time unit value indicated by the higher layer and/or the fixed time unit value and/or the time unit value reported by the user equipment.

In another aspect of the present invention, there is provided a method for positioning performed by the user equipment in a wireless communication system, wherein, the first downlink signal includes one or more of the following: the SSB, the physical downlink control channel (PDCCH) and/or physical downlink shared channel (PDSCH) for scheduling and/or transmitting the SIB, the PDCCH and/or PDSCH for scheduling and/or transmitting control resource set 0 (CORESET0), the PDCCH and/or PDSCH for scheduling and/or transmitting message 2 (MSG2)/message B (MSGB), the PDCCH and/or PDSCH for scheduling and/or transmitting paging, and PDCCH and/or PDSCH for scheduling and/or transmitting downlink small data transmission (DL SDT) signals.

In another aspect of the present invention, there is provided a method for positioning performed by the user equipment in a wireless communication system, wherein receiving the signal for positioning and/or the first downlink signal according to priority information includes at least one of the following: when the priority of the signal for positioning is higher than that of the first downlink signal, the user equipment preferentially receives and/or measures the signal for positioning; when the priority of the signal for positioning is lower than that of the first downlink signal, the user equipment preferentially receives the first downlink signal; and when the priority of the signal for positioning is the same as the first downlink signal, the user equipment simultaneously receives the signal for positioning and the first downlink signal, and/or it is up to the user equipment implementation to receive one or more or all of the signal for positioning or the first downlink signal.

In another aspect of the present invention, there is provided a method for positioning performed by the user equipment in a wireless communication system, further comprising activating and/or deactivating the configured windows.

In another aspect of the present invention, there is provided a method for positioning executed by the user equipment in a wireless communication system, wherein the activating and/or deactivating the configured window includes: the window is in an active state by default, and the window is deactivated according to the instruction of the base station side.

In another aspect of the present invention, there is provided a method for positioning executed by the user equipment in a wireless communication system, which further comprises: when the downlink bandwidth part (DL BWP) where the window is located receives the DCI BWP indicator, performing at least one of the following: 1) the user equipment ignores the DCI BWP indicator in the window, indicates that the DL BWP is not switched, and informs the base station to remain in the current DLBWP; 2) the user equipment informs the base station equipment to remain in the current DL BWP during the first time period from receiving the DCI BWP indicator to the end of the current window, and then the user equipment switches to the BWP indicated by the DCI BWP indicator with a delay; and 3) the user equipment informs the base station equipment to remain in the current DL BWP during the second time period from receiving the DCI BWP indicator to completing the signal measurement report for positioning, and then the user equipment spontaneously switches to the BWP indicated by the DCI BWP indicator.

In another aspect of the present invention, there is provided a method for positioning executed by the user equipment in a wireless communication system, wherein reporting measurement result includes at least one of the following: 1) when the window in the active DL BWP ends, the measurement result of the signal for positioning is immediately reported in the corresponding UL BWP; 2) if the corresponding measurement result has been obtained in the first N time units of the window in the active DL BWP, the measurement result of the signal for positioning is reported from the time of the (N+1th) time unit to the time before the end of the window; and 3) after the end of multiple windows in the active DL BWP, the measurement result of multiple windows in the corresponding UL BWP is reported simultaneously through PUSCH.

In another aspect of the present invention, there is provided a method for positioning executed by the user equipment in a wireless communication system, which further comprises: after the measurement result is reported, if the window is configured by the user equipment, the user equipment spontaneously terminates the configured window; if the window is configured by the base station or higher layer functional entity, after the base station or higher layer functional entity receives the measurement report, the user equipment receives the indication information for terminating the window through at least one of the DCI signalling, the RRC signalling, the DL MAC CE, the NRPPa message and the LPP message.

In another aspect of the present invention, there is provided a user equipment, which includes: a memory configured to store computer programs; and a processor configured to run the methods described in any one of the above aspects.

In another aspect of the present invention, there is provided a method for positioning performed by a base station in a wireless communication system, which includes: receiving a measurement result of measuring the signal for positioning from the user equipment, wherein the measurement is performed in a window configured according to window configuration information of resources for configuring the window.

In another aspect of the present invention, there is provided a method for positioning performed by a base station in a wireless communication system, further comprising determining window configuration information by at least one of the following: through at least one of the downlink control information (DCI) signalling, the radio resource control (RRC) signalling, the downlink media access control element (DL MAC CE) signalling, the new wireless (NR) positioning protocol A (NRPPa) message and the long term evolution (LTE) positioning protocol (LPP) message, transmitting the user equipment the window configuration information configured by the base station which is indicated by the higher layer functional entity and/or window configuration information configured directly by the higher layer functional entity; transmitting the window configuration information to the user equipment through at least one of the DCI signalling, the RRC signalling, the DL MAC CE signalling, the NRPPa message and the LPP message; and receiving the window configuration information determined by the user equipment itself and reported by the user equipment through at least one of the uplink control information (UCI) signalling, the RRC signalling, the uplink MAC control element (UL MAC CE) signalling, the NRPPa message and the LPP message.

In another aspect of the present invention, there is provided a method for positioning performed by the base station in a wireless communication system, wherein the signal for positioning include at least one of the positioning reference signal (PRS), the synchronization signal block (SSB), the channel state information reference signal (CSI-RS), the tracking reference signal (TRS), the SSB for positioning, the CSI-RS for positioning and the TRS for positioning.

In another aspect of the present invention, there is provided a method for positioning performed by the base station in a wireless communication system, wherein the window configuration information includes at least one of the following: information related with the bandwidth of the window, information related with the period of the window, information related with the starting point of period of the window, information related with the duration of the window, and information related with the starting point of the window.

In another aspect of the present invention, there is provided a method for positioning performed by the base station in a wireless communication system, further comprising: receiving a processing capability of the user equipment of the signal for positioning from the user equipment.

In another aspect of the present invention, there is provided a method for positioning performed by the base station in a wireless communication system, wherein receiving the processing capability of the user equipment of the signal for positioning from the user equipment includes: receiving indication information from the user equipment, which is used to indicate whether the signal for positioning or other downlink signals/channels can be received at the same time in a time unit within the window; or receiving from the user equipment a notification about whether to receive other downlink signals in the window through at least one of the UCI message, the RRC signalling and the MAC CE signalling.

In another aspect of the present invention, there is provided a method for positioning performed by the base station in a wireless communication system, further comprising: the base station indicates the priority of the signal for positioning and other downlink signals/channels to the user equipment.

In another aspect of the present invention, there is provided a method for positioning performed by the base station in a wireless communication system, further comprising: activating and/or deactivating the configured window, wherein the activating and/or deactivating the configured window comprises: the window is activated by default, and the base station instructs the user equipment to deactivate the window.

In another aspect of the present invention, there is provided a method for positioning performed by the base station in a wireless communication system, further comprising: if the window is configured by the base station, after receiving the measurement report, receiving indication information of terminating the window from the user equipment through at least one of the DCI signalling, the RRC signalling, the DL MAC CE, the NRPPa message and the LPP message.

In another aspect of the present invention, there is provided a base station, which includes a memory configured to store computer programs; and a processor configured to run the computer programs to implement the methods according to any one of the above aspects.

### MODE FOR THE INVENTION

The technical scheme of this embodiment can be applied to various communication systems, such as Global System for Mobile Communications (GSM) system, code division multiple access (CDMA) system, Wideband Code Division Multiple Access (WCDMA) system, general packet radio service (GPRS), long term evolution (LTE) system, LTE frequency division duplex (FDD) system, LTE time division duplex (TDD), universal mobile telecommunications system (UMTS), worldwide interoperability for microwave access (WiMAX) communication system, 5th generation (5G) system or new radio (NR), etc. In addition, the technical scheme of the embodiment of this application can be applied to future-oriented communication technology.

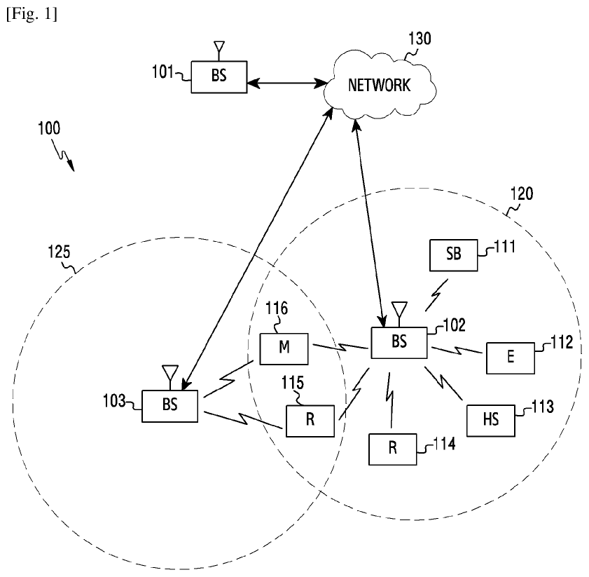

FIG. 1 shows an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. Other well-known terms such as “mobile station”, “user station”, “remote terminal”, “wireless terminal” or “user apparatus” can be used instead of “user equipment” or “UE”, depending on the type of the network. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

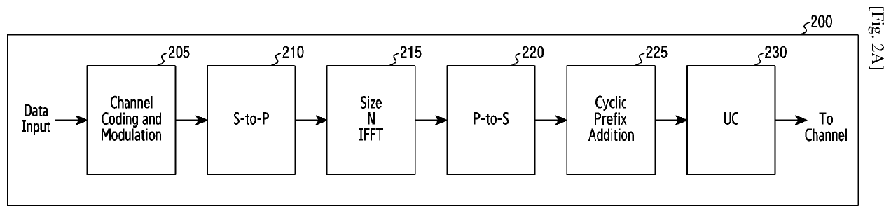

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at the UE 116 after passing through the wireless channel, and operations in reverse to those at gNB 102 are performed at the UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

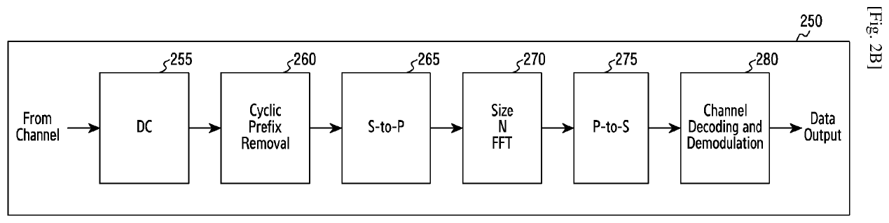

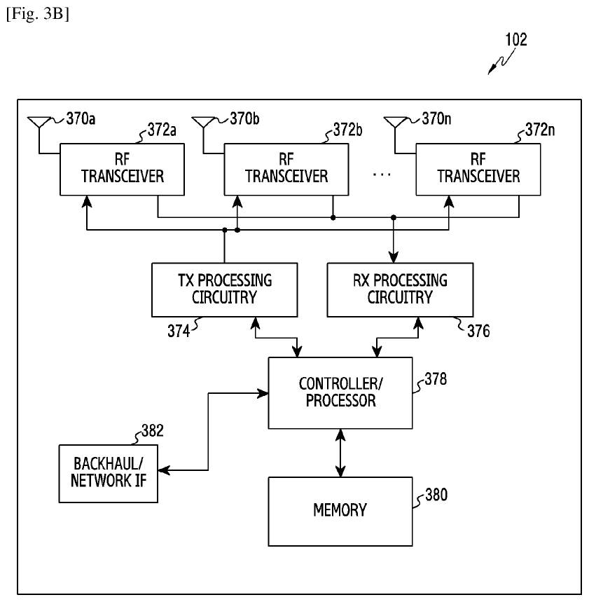

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE. For example, the UE 116 may include more or fewer components than those described above. In addition, the UE 116 corresponds to the UE of the FIG. 5.

UE 116 includes an antenna 305, a radio frequency (RF) transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of the UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of performing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides the UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of the UE 116 can input data into the UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of the UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

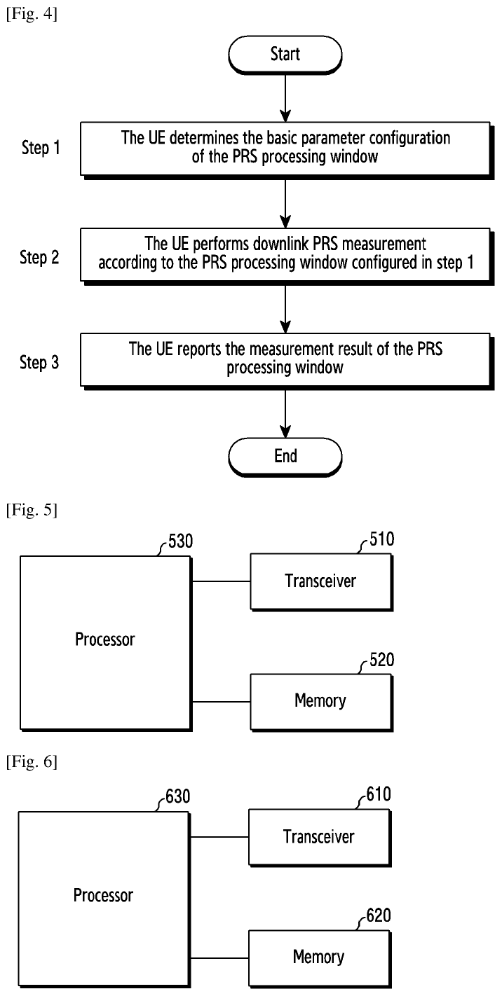

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382. However, the components of the gNB 102 are not limited thereto. For example, the gNB 102 may include more or fewer components than those described above. In addition, the gNB 102 corresponds to the base station of the FIG. 6.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of performing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

Exemplary embodiments of the present disclosure are further described below with reference to the accompanying drawings.

Those skilled in the art can understand that the singular forms “a”, “an”, and “the” used here can also include plural forms unless specifically stated. It should be further understood that the word “comprising” used in the specification of this application means the presence of said features, integers, steps, operations, elements and/or components, but does not exclude the presence or addition of one or more other features, integers, steps, operations, elements, components and/or groups thereof. It should be understood that when an element is described as “connected” or “coupled” to another element, it may be directly connected or coupled to other elements, or there may be intervening elements. In addition, as used herein, the statements “connected” or “coupled” may include wireless connection or wireless coupling. As used herein, the phrase “and/or” includes all or any unit and all combinations of one or more associated listed items.

Those skilled in the art can understand that unless otherwise defined, all terms (including technical terms and scientific terms) used here have the same meaning as those commonly understood by ordinary technicians in the field to which this application belongs. It should also be understood that terms such as those defined in the general dictionary should be understood to have meanings consistent with those in the context of the prior art, and will not be interpreted with idealized or overly formal meanings unless specifically defined as here.

It can be understood by those skilled in the art that “terminal” and “terminal equipment” used here include not only the equipment including wireless signal receiver which is a wireless signal receiving equipment without capability of transmitting signals, but also the equipment including receiving and transmitting hardware which is capable of bidirectional communication on bidirectional communication link. Such devices may include: cellular or other communication devices with single-line display or multi-line display or cellular or other communication devices without multi-line display; PCS (Personal Communications Service), which can combine voice, data processing, fax and/or data communication capabilities; PDA (Personal Digital Assistant), which may include radio frequency receiver, pager, internet/intranet access, web browser, notepad, calendar and/or GPS (Global Positioning System) receiver; conventional laptops and/or palmtop computers or other devices having and/or including a radio frequency receiver. As used herein, “terminal” and “terminal equipment” can be portable, transportable, installed in the (aviation, maritime and/or land) transport, or suitable and/or configured to operate locally, and/or operate in any other place on the earth and/or space in a distributed manner. As used herein, “terminal” and “terminal equipment” can also be a communication terminal, an Internet terminal and a music/video playing terminal, such as PDA, MID (Mobile Internet Device) and/or a mobile phone with music/video playing functions, a smart TV, a set-top box and other devices.

The time domain unit (also called time unit) in this invention can be: an OFDM symbol, an OFDM symbol group (composed of multiple OFDM symbols), a time slot, a time slot group (composed of multiple time slots), a subframe, a subframe group (composed of multiple subframes), a system frame and a system frame group (composed of multiple system frames). The time unit can also be an absolute time unit, such as 1 millisecond, 1 second, etc. Furthermore, the time unit can also be a combination of various granularities, such as N1 time slots plus N2 OFDM symbols.

The frequency domain unit in this invention can be: a subcarrier, a subcarrier group (composed of multiple subcarriers), a resource block (RB), which can also be called a physical resource block (PRB), a resource block group (composed of multiple RBs), a band part (BWP), a band part group (composed of multiple BWPs), a band/carrier, a band group/carrier group. The frequency domain unit can also be an absolute frequency domain unit, such as 1 Hz, 1 kHz, etc. Furthermore, the frequency domain unit can also be a combination of various granularities, such as M1 PRBs plus M2 subcarriers. The term “transmit” in the present invention can be used interchangeably with “transmission”, “report”, “notification” and so on, without departing from the scope of the present invention.

The text and drawings are provided as examples only to help readers understand the present disclosure. They are not intended and should not be interpreted as limiting the scope of the present disclosure in any way. Although some embodiments and examples have been provided, based on the disclosure herein, it is obvious to those skilled in the art that changes can be made to the illustrated embodiments and examples without departing from the scope of this disclosure.

Transmission in the wireless communication system mainly includes: downlink transmission from the 5G base station and LTE base station (NG radio Access Network, NG-RAN) to the User Equipment (UE), and uplink transmission from the UE to NG-RAN.

Transmission nodes used for positioning in wireless communication systems such as current wireless communication systems include: a Gateway Mobile Location Center (GMLC) that initiates positioning request information, a UE that initiates positioning request information, a Access and Mobility Management Function (AMF) for receiving positioning request information, a Location Management Function (LMF) for UE positioning and positioning assistance data distribution, a NG-RAN node for broadcasting positioning assistance data and uplink positioning measurement, and a UE for downlink positioning measurement.

In the downlink positioning process, such as the current downlink positioning process, the positioning process based on the New Radio Positioning Protocol A (NRPPa) is divided into five steps: in the Step 1, GMLC or UE needing location information initiates a location service request to AMF, or AMF spontaneously initiates a location service request to emergency rescue users; in the Step 2, AMF transmits a location service request message to LMF; in Step 3, after receiving a positioning request message, LMF instructs NG-RAN to transmit positioning assistance messages to the UE through AMF, requests NG-RAN to configure reference signals for the UE to perform UE-based and UE-assisted positioning, and reports the measurement information to LMF after the UE completes the downlink positioning measurement; in Step 4, LMF feeds back the measurement result to AMF; and in Step 5, the AMF feeds back the measurement result to GMLC or the UE that initiates the request.

In the current NR Radio Resource Control (RRC) positioning process, LMF transmits a positioning request message to UE through gNB. After receiving the positioning request message, UE initiates RSTD measurement or NR DL-PRS measurement between devices. The above-mentioned measurement can be divided into two steps: 1) If the UE requests measurement gaps (MG) to perform location measurement under the condition that the MG are not configured or sufficient, or if the UE needs a certain time interval to acquire the subframe and time slot configuration of the target system before requesting MG for Reference Signal Time difference (RSTD) between devices, the UE transmits RRC location measurement indication information to gNB which provides services to the UE, indicating that UE starts to perform location measurement or acquire subframe and time slot configuration, and requests information for configuring appropriate MG from gNB. When the gNB is configured with MG, the UE starts to perform location measurement or timing acquisition process. 2) When the UE completes the positioning process which requires MG, the UE transmits another RRC location measurement indication message to the gNB that provides services for the UE. The message indicates that the UE has completed the location measurement or timing acquisition process.

In the above positioning process, the time delay is large because MG needs to be configured by the RRC signalling. In order to realize low-delay positioning, a window (or time-frequency interval) other than MG is introduced specially for measuring the signal for positioning. Subject to UE capabilities, the configured window can complete the receiving, the measuring, and the reporting of signal for positioning with lower time delay. Therefore, in the case of using windows to receive downlink signal for positioning, how to configure windows and complete the positioning, the measuring, and the reporting is a problem to be solved in order to reduce positioning delay.

For example, the present invention takes the PRS processing window as an example to introduce the receiving and measuring method of the positioning signal based on the window or time-frequency interval.

Subject to UE capabilities, the configured PRS processing window, which is specially used for PRS measurement, can complete the receiving, the measuring, and the reporting of PRS signal with lower time delay. Therefore, in the case of using the PRS processing window to receive downlink PRS, how to configure the PRS processing window and complete the positioning, the measuring, and the reporting is a problem to be solved in order to reduce positioning delay.

The embodiment of the invention provides a receiving and measuring method of downlink positioning reference signal PRS based on PRS processing window.

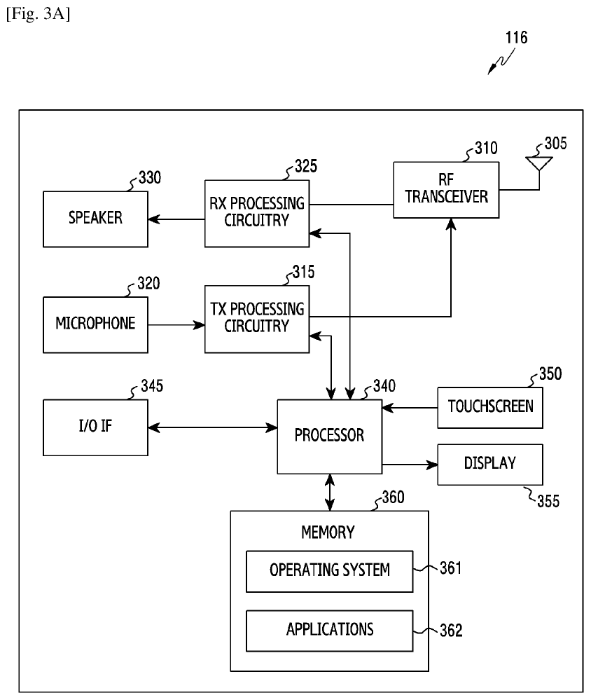

Referring to FIG. 4, in Step 1, the UE determines the basic parameter configuration of the PRS processing window; in Step 2, the UE performs downlink PRS measurement according to the PRS processing window configured in Step 1; and in Step 3, the UE reports the measurement result of the PRS processing window.

It should be clear to those skilled in the art that the present invention is not limited to the PRS processing window shown in FIG. 4 as an example. According to an embodiment of the present invention, there can also be provided a method for positioning performed by a user equipment in a wireless communication system, which includes: determining window configuration information, wherein the window configuration information is used for configuring window resources; measuring the signal for positioning in the window according to the window configuration information; and reporting the measurement result.

It should be clear to those skilled in the art that the signal for positioning include at least one of the followings without departing from the scope of the present invention: positioning reference signal PRS, synchronization signal block SSB, channel state information reference signal CSI-RS, tracking reference signal TRS, SSB for positioning, CSI-RS for positioning, and TRS for positioning, etc. In addition, it should be clear to those skilled in the art that the PRS processing window can be replaced by the PRS priority window without departing from the scope of the present invention.

The configured window can complete the measuring and the reporting with lower time delay by introducing the window specifically for measuring the signal for positioning.

Specifically, in the method for receiving and measuring the downlink positioning reference signal PRS based on the PRS processing window proposed by the invention, the UE determines by itself or obtains the relevant configuration information of the PRS processing window for PRS reception through the NG-RAN/LMF higher layer signaling (such as the system information MAC CE and/or the UE-specific RRC configuration information and/or the NRPPa message and/or the LPP message) and/or physical layer signaling (such as downlink control information DCI), specifies the reception priority of PRS in the PRS processing window, instructs to reconfigure or maintain the previous PRS processing window when DL BWP is switched, and determines the reporting method of PRS measurement result and the method of terminating the PRS processing window.

Specifically, the configuration information acquisition method of the PRS processing window includes one or a combination of the following items:
1. The higher layer functional entity (such as LMF) instructs the base station device (such as NG-RAN) to configure the PRS processing window for the UE and/or the higher layer functional entity (such as LMF) directly configures the PRS processing window for the UE. Because the higher layer functional entity (such as LMF) can obtain the configuration information of multiple base station devices (such as NG-RAN), the higher layer functional entity (such as LMF) can consider the transmission situation of PRS resources in the current serving cell and adjacent cells as a whole when configuring the PRS processing window. The specific configuration method is performed with at least one of the following:
   The DCI signalling
   The RRC signalling
   The DL MAC CE
   The NRPPa message
   The LPP message
2. The base station equipment (such as NG-RAN) transmits the PRS processing window configuration information for receiving PRS measurements to the UE. Delegating the authority to configure the PRS processing window to the base station device (such as NG-RAN) can reduce the configuration delay of the PRS processing window. The specific method is performed with at least one of the following:
   The DCI signalling
   The RRC signalling
   The DL MAC CE
   The NRPPa message
   The LPP message
3. The UE determines the configuration information of the PRS processing window, and notifies the base station devices (such as NG-RAN) and/or higher layer function entities (such as LMF). The specific method is performed with at least one of the following:
   The UCI signalling
   The RRC signalling
   The UL MAC CE
   The NRPPa message
   The LPP message

The basic configuration information of PRS processing window includes at least one or a combination of the following:
1. Configuring the bandwidth of the PRS processing window. Specifically, the method for determining the bandwidth of the PRS processing window includes at least one of the following:
   The bandwidth of the PRS processing window is configured independently.
   The bandwidth of the PRS processing window is equal to the bandwidth of the DL BWP.
   The bandwidth of the PRS processing window is equal to the carrier bandwidth, that is, the sum of the bandwidths of all BWPs, for example, the sum of the bandwidths of four BWPs in the current system.
   The bandwidth of the PRS processing window is equal to 1/N of the bandwidth of the DL BWP, where N is a number greater than 0 (for example, positive integer, decimal), and can be a number less than 1. The value of N can be a variable configured by the base station or a fixed value.
   The bandwidth of the PRS processing window is equal to 1/N of the carrier bandwidth, where N is a number greater than 0 (for example, positive integer, decimal), and can be a number less than 1. The value of N can be a variable configured by the base station or a fixed value.
   The bandwidth of the PRS processing window is equal to the bandwidth of currently configured and/or PRS measurement (activated) PRS resource and/or PRS resource set and/or frequency resource layer.
2. Configuring the transmission/configuration period of the PRS processing window. Specifically, the method for determining the transmission/configuration period of the PRS processing window includes at least one of the following:
   The transmission/configuration period of the PRS processing window is configured independently.
   The transmission/configuration period of the PRS processing window is equal to a first transmission period, which is the transmission period of MG or the transmission period of PRS resources, for example, it can be equal to 80 ms or 160 ms of the transmission period of MG.
   The transmission/configuration period of the PRS processing window is configured according to a first transmission period, and is equal to 1/M of the first transmission period. The value of M is a number greater than 0 (for example, positive integer, decimal), and can be a number less than 1. The value of M can be a variable configured by the base station or a fixed value.
   The transmission/configuration period of the PRS processing window is configured according to a first transmission period. Specifically, the transmission/configuration period of the PRS processing window is an offset of the first transmission period in time domain, and is equal to the first transmission period plus an offset R. The value of R ranges from negative infinity to positive infinity, and the value of R can be a variable configured by the base station or a fixed value.
3. Configuring the starting point of the transmission/configuration period for the PRS processing window. Specifically, the method for determining the starting point of the transmission/configuration period for the PRS processing window includes at least one of the following:
   The starting point of the transmission/configuration period for the PRS processing window is configured independently.
   The starting point of the transmission/configuration period for the PRS processing window is equal to the starting point of the first transmission period.
   The starting point of the transmission/configuration period for the PRS processing window is configured according to the starting point of the first transmission period, and is equal to the starting point of the first transmission period plus an offset R. The value of R ranges from negative infinity to positive infinity, and the value of R can be a variable configured by the base station or a fixed value.
4. Configuring the duration of the PRS processing window. Specifically, the method for determining the duration of the PRS processing window includes at least one of the following:
   The duration of the PRS processing window is configured independently. The duration of the PRS processing window can be jointly configured according to the subcarrier spacing scs=2^{μ}×15 KHz and the transmission period of MG/PRS. The number of time slots N in the current wireless frame can be calculated through the given subcarrier spacing, and the starting point of MG and/or PRS can be combined to calculate the duration of the PRS processing window. For example, the PRS processing window period is derived according to the period of MG, when the period of MG is 80 ms and the duration is 10 ms, the duration of the PRS processing window is calculated as shown in Table 1. The duration of the PRS processing window is equal to the minimum period of the PRS transmission period supported in one MG.

TABLE 1
Deriving the parameter configuration of the PRS processing window
according to MG with a period of 80 ms and a duration of 10 ms.

| | | | Transmission | |
|---|---|---|---|---|
| | Length of | | period of | Duration of the PRS |
| | the time | | PRS in | processing window |
| μ | slot (ms) | Nₛₗₒₜ^{frame, μ} | MG (ms) | (time unit) |
| 0 | 1 | 10 | 4, 8, 5, 10 | 4 |
| 1 | 0.5 | 20 | 8, 16, 10, 20 | 8 |
| 2 | 0.25 | 40 | 16, 32, 20, 40 | 16 |
| 3 | 0.125 | 80 | 32, 64, 40, 80 | 32 |

The duration of the PRS processing window is equal to the first duration, which is the duration of MG or the duration of the PRS resources in one period, for example, it can be equal to the duration of MG of 10 ms or 20 ms.
The duration of the PRS processing window is configured according to the first duration, for example, the duration of the PRS processing window is equal to 1/M of the first duration, and M is a number greater than 0 (for example, positive integer, decimal), and can be a number less than 1, and the value of M can be a variable configured by the base station or a fixed value.
5. Configuring the starting point of the PRS processing window, specifically, the method for determining the starting point of the PRS processing window includes at least one of the following:
   The starting point of the PRS processing window is configured independently.
   The starting point of the PRS processing window is equal to the first starting point, which is the starting point of MG or the starting point of the PRS resources in one period, and the position of the first starting point is taken as the starting point of the PRS processing window.
   The starting point of the PRS processing window is an offset of the first starting point position, which is equal to the first starting point position plus an offset R. The value of R ranges from negative infinity to positive infinity, and the value of R can be a variable configured by the base station or a fixed value.

When the UE obtains the configuration information of the PRS processing window, it performs downlink PRS measurement according to the configured PRS processing window. At this time, it is necessary to determine the priority of the PRS signals and other DL signals/channels in the time unit within the window or in the time unit where the transmitted signal for positioning overlaps with other downlink signals/channels. To realize this function, UE declares the PRS processing capability and window suitable for each UE in each FR or each frequency band, and the method includes at least one of the following:
Subject to UE capabilities, when the base station equipment (such as NG-RAN) and/or higher layer functional entities (such as LMF) configure the PRS processing window for the UE or the UE determines the PRS processing window by itself, the UE reports relevant binary indicator factors to the base station equipment (such as NG-RAN) and/or higher layer functional entities (such as LMF) to declare whether it can simultaneously receive the PRS resources and other downlink signals overlapped with the PRS resources. When the binary factor is 0, it means that the UE can only process the PRS signals in the PRS processing window, and other overlapped downlink signals/channels should be retransmitted to ensure correct reception. When the binary factor is 1, the UE can simultaneously receive the PRS signals and the overlapped downlink signals/channels in the PRS processing window.
Subject to UE capabilities, when the base station equipment (such as NG-RAN) and/or the higher layer functional entities (such as LMF) configure the PRS processing window for the UE or the UE determines the PRS processing window by itself, the UE informs the base station equipment (such as NG-RAN) and/or the higher layer functional entities (such as LMF) through UCI signalling whether other downlink signals can be received at the time-frequency resources for receiving the PRS resources.
Subject to UE capabilities, when the base station equipment (such as NG-RAN) and/or higher layer functional entities (such as LMF) configure the PRS processing window for the UE or the UE determines the PRS processing window by itself, the UE informs the base station equipment (such as NG-RAN) and/or higher layer functional entities (such as LMF) through the RRC signalling whether other downlink signals can be received at the time-frequency resources for receiving the PRS resources.
Subject to UE capabilities, when the base station equipment (such as NG-RAN) and/or the higher layer functional entities (such as LMF) configure the PRS processing window for the UE or the UE determines the PRS processing window by itself, the UE informs the base station equipment (such as NG-RAN) and/or the higher functional entities (such as LMF) through MAC CE signaling whether other downlink signals can be received at the time-frequency resources for receiving PRS resources.

The priority relationship between the PRS resources and the first downlink signals is determined within the time range within the PRS processing window and/or on the symbols where the PRS overlaps with the first downlink signal, wherein, the first downlink signal includes SSB, physical downlink control channel PDCCH and/or physical downlink shared channel PDSCH for scheduling and/or transmitting the SIB, the PDCCH and/or PDSCH for scheduling and/or transmitting control resource set 0 (CORESET0), the PDCCH and/or PDSCH for scheduling and/or transmitting message 2 (MEG2)/message B (MSGB), the PDCCH and/or PDSCH for scheduling and/or transmitting the paging, and the PDCCH and/or PDSCH for scheduling and/or transmitting downlink small data transmission (DL SDT) signals. The priority relationship can be divided into three categories, that is, the PRS resources have higher priority than some or all of the first downlink signals, the PRS resources have lower priority than some or all of the first downlink signals, and the PRS resources have the same priority as some or all of the first downlink signals. The UE can determine the priority relationship between the PRS resources and the first downlink signals by implied and/or indicated by the base station. Taking SSB as an example, the configuration method for the priority relationship between the PRS resources and the SSB includes at least one of the following:
The PRS resources have higher priority than the SSB, that is, when the PRS resources and the SSB are transmitted simultaneously in the PRS processing window, the UE receives and/or measures the PRS resources with higher priority;
The PRS resources have lower priority than the SSB, that is, when the PRS resources and the SSB are transmitted at the same time in the PRS processing window, the UE receives the SSB with higher priority;
The PRS resources and the SSB have the same priority, when the PRS resources and the SSB have the same priority, the UE can receive the PRS resources and the SSB at the same time, and/or the UE can independently determine to receive one or part of or all of the PRS resources or the first downlink signals. Considering that the PRS resources and the SSB have a TypeD quasi-co-location (QCL) relationship, which includes but is not limited to the same time delay and Doppler frequency shift, the UE can configure related messages on the next time unit in advance according to the received PRS resources and/or the SSB, and the related messages include but are not limited to the next PRS resource and/or the SSB, thus reducing the errors caused by time changes and improving the accuracy of positioning messages.

The UE determines the priority of the PRS and other downlink channels and/or signals (i.e., non-PRS signals or channels, such as the first downlink signals) in the PRS processing window by receiving the indication of PRS priority of the PRS processing window during the PRS measurement and/or reception. The specific method includes at least one or a combination of the following:
When the priority option and/or state indication is not provided, the UE determines that the PRS priority is higher than other downlink channels and/or downlink signals (i.e., non-PRS signals or channels, such as the first downlink signals).
The priority option and/or state indication is determined by the RRC signalling. It can be considered that the priority of the PRS processing window remains unchanged for a period of time, indicating the priority of the PRS processing window through the RRC signalling reduces the uncertainty and processing delay caused by multiple dynamic indications. Preferably, a separate priority option and/or state indication indicated by the RRC signalling is included in each PRS processing window configuration, and multiple or all of the PRS processing window configurations apply a same priority option and/or state indicated by the RRC signalling.
The priority option and/or state indication is determined by the MAC CE signalling and/or DCI signalling activated by the PRS processing window. Compared with the RRC signalling, the MAC CE can flexibly and quickly indicate the priority of the PRS in the PRS processing window, and reduce the system processing delay in a single PRS priority indication.

The configuration method of the priority option and/or state indication message of the PRS priority in the PRS processing window includes at least one or a combination of the following:
A 2-bit RRC signalling is used to indicate the PRS priority in the PRS processing window. Subject to UE capabilities, if the UE supports multiple PRS priority options, 1-bit (the high-order bit or the low-order bit) indicator within the 2-bit RRC signalling can be used to indicate the option 1 with two priority states and the option 2 with three priority states, and the other 1-bit (corresponding the low-order bit or the high-order bit) indicator within the 2-bit RRC signalling can be used to indicate states under different priority options. For example, if the 1-bit of the high-order bit indicator in the 2-bit RRC signalling indicates different priority options, then the 1-bit of the low-order bit indicator could indicate the state under different priority options, specifically:
00 indicates the state 1 of the option 1 with two priorities supported by the configured PRS processing window: that is, the PRS is higher priority than other downlink channels and/or downlink signals (i.e. non-PRS signals or channels, such as the first downlink signals);
01 indicates the state 2 of the option 1 with two priorities supported by the configured PRS processing window: that is, the PRS is lower priority than other downlink channels and/or downlink signals (i.e. non-PRS signals or channels, such as the first downlink signals);
10 indicates the state 2 of the option 2 with three priorities supported by the configured PRS processing window: that is, the PRS is lower priority than PDCCH and URLLC PDSCH and higher priority than other downlink channels and/or downlink signals (i.e. non-PRS, non-PDCCH, non-URLLC PDSCH, non-URLLC signals or channels). The URLLC channel corresponds a dynamically scheduled PDSCH whose PUCCH resource for carrying ACK/NAK is marked as high priority;
11 indicates the state 3 of the option 2 with three priorities supported by the configured PRS processing window: that is, the PRS is lower priority than other downlink channels and/or downlink signals (i.e. non-PRS signals or channels, such as the first downlink signals).

Wherein, the state 1 of the option 2 with three priorities could be that the PRS is higher priority than other downlink channels and/or downlink signals (i.e., non-PRS signals or channels, such as the first downlink signals). Preferably, the above 2-bit RRC signalling can also be written as:
PRS-Priority-Indicator CHOICE{
optionValue ENUMERATED {0,1},
stateValue ENUMERATED {0,1}
}

Wherein, optionValue indicates the Option 1 with two priority states and the Option 2 with three priority states, and stateValue indicates the states under different priority options.
Subject to UE capabilities, a 1 bit RRC signalling or DCI signalling or MAC CE signalling (activated) is used to indicate the priority option and/or state of the PRS. In a case that the UE reports the priority option supporting the PRS measurement and/or reception in the PRS processing window, when the priority option and/or state indication are not provided, the UE determines that PRS is higher priority than other downlink channels and/or downlink signals (i.e. non-PRS signals or channels, such as the first downlink signals). Subject to UE capabilities, when the UE supports the Option 1 with two priority states, “0” means that the default priority state of the PRS remains unchanged, that is, the PRS is higher priority than other downlink channels and/or downlink signals (i.e. non-PRS signals or channels, such as the first downlink signals); and “1” means that the default priority state of the PRS is changed, that is, the PRS is lower priority than other downlink channels and/or downlink signals (i.e., non-PRS signals or channels, such as the first downlink signals). When the UE supports the Option 2 with three priority states, “0” indicates the state 2 within three PRS priorities, that is, the PRS is lower priority than PDCCH and URLLC PDSCH and higher priority than other downlink channels and/or downlink signals (i.e. non-PRS, non-PDCCH, non-URLLC PDSCH, non-URLLC signals or channels), the URLLC channel corresponds a dynamically scheduled PDSCH whose PUCCH resource for carrying ACK/NAK is marked as high priority; and “1” indicates the state 3 within three PRS priorities: the PRS is lower priority than other downlink channels and/or downlink signals (i.e. non-PRS signals or channels, such as the first downlink signals).
Subject to UE capabilities, a 1 bit RRC signalling and/or a 1 bit DCI or MAC CE are used to indicate the priority state of the PRS. In a case when the UE reports it support multiple PRS measurement and/or reception priority options for a PRS processing windows, when the priority option and/or state indication is not provided (i.e., implied by UE capability), the UE determines that PRS is higher priority than other downlink channels and/or signals (that is, non-PRS signals or channels, such as the first downlink signals). If the 1 bit RRC signalling is “1”, the implied PRS priority state for the PRS processing window is changed, that is, when the UE supports two priority states of the Option 1, at this time, the PRS priority state will be changed to be different from the implied PRS priority state, for example, the PRS priority will be changed to be lower priority than other downlink channels and/or downlink signals (that is, non-PRS signals or channels, such as the first downlink signals); otherwise, the implied PRS priority state for the PRS processing window will be maintained. When the UE supports the three priority states of the Option 2, an additional 1 bit DCI or MAC CE (activated) signalling is used to indicate the PRS priority in the PRS processing window. For example, a DCI or MAC CE (activated) signalling of “1” indicates the state 2 of the Option 2 within three priority states: that is, the PRS is lower priority than PDCCH and URLLC PDSCH and higher priority than other downlink channels and/or downlink signals (i.e. non-PRS, non-PDCCH, non-URLLC PDSCH, non-URLLC signals or channels), the URLLC channel corresponds a dynamically scheduled PDSCH whose PUCCH resource for carrying ACK/NAK is marked as high priority; and “0” indicates the state 3 of the Option 2 within three priority states: the PRS is lower priority than other downlink channels and/or downlink signals (i.e. non-PRS signals or channels, such as the first downlink signals).
The determined PRS priority option and/or state with other downlink signals or other downlink channels can be applied in the first PRS processing window after N+X time, and/or in the PRS processing window containing overlapping/conflicting with other downlink signals or downlink channels after N+X time, wherein N is the end position of PDCCH corresponding to the DCI, and/or the end position of PDSCH containing the RRC signalling or the MAC CE, and/or the end position of PDCCH corresponding to PDSCH. And X is the time unit value indicated by the higher layer and/or the fixed time unit value and/or the time unit value reported by the UE (related to the processing capacity of the UE), and preferably, X=0.

In order to reduce the system processing delay caused by configuring the PRS processing windows, pre-configured PRS processing windows are supported, and a unique ID number is configured for each pre-configured PRS processing window. The UE indicates the activation or deactivation of the PRS processing windows through the received ID. While pre-configuring the PRS processing window, the priority relationship between the PRS and other downlink channels and/or signals (i.e., non-PRS signals or channels, such as the first downlink signals) in the PRS processing window are configured.

In order to support the transmission requirements of all kinds of high-reliability and low-delay services in the positioning process, and avoid the extra transmission delay caused by the priority transmission of the PRS resources in the PRS processing window, the configured PRS processing window should be able to be activated and deactivated. In the procedure of downlink positioning, multiple PRS processing windows can be activated and deactivated. The activation and deactivation method of the PRS processing window includes at least one of the following:
The PRS processing window is activated by default, and the deactivation of the PRS processing window is indicated by DL MAC CE.
The PRS processing window is activated by default, and LMF indicates whether to deactivate the periodically configured PRS processing window by a 1-bit indicator, wherein “1” indicates that the currently configured PRS processing window is activated and “0” indicates that the currently configured PRS processing window is deactivated.
The PRS processing window is activated by default, and the periodically configured PRS processing window is deactivated by higher layer signaling (such as the RRC configuration information dedicated to the UE) and/or physical layer signaling (such as the downlink control information DCI), wherein “1” indicates that the currently configured PRS processing window is activated and “0” indicates that the currently configured PRS processing window is deactivated.

When receiving the DCI BWP indicator indicating the switch of the DL BWP during the PRS processing window in order to ensure the integrity of the PRS processing window, the switch method of the DL BWP includes at least one of the following:
The UE does not expect to switch to another BWP from the BWP configured with the PRS processing window. The DCI BWP indicator in the PRS processing window would be ignored, the DL BWP would be enforced not to switch, and the base station equipment (such as NG-RAN) is notified to maintain transmitting control information and data information in the current DL BWP.
The UE sets a bwp-SwitchingTimer in the PRS processing window, the duration of which is from receiving the DCI BWP indicator to the end of the current PRS processing window, and informs the base station equipment (such as NG-RAN) to maintain transmitting control information and data information in the current DL BWP until the bwp-SwitchingTimer is 0, at which time the UE delays switching to the BWP indicated by the DCI BWP indicator.
Before DL BWP switching, the UE reconfigures the PRS processing window to measure the downlink PRS resources, and the obtained measurement result is reported to LMF separately or in combination with the measurement result of PRS resources before BWP switching.
The UE sets a bwp-SwitchingTimer in the PRS processing window, the duration of which is from receiving the DCI BWP indicator to completing the PRS measurement report, and informs the base station equipment (such as NG-RAN) to maintain transmitting control information and data information in the current DL BWP until the bwp-SwitchingTimer is 0, at which time the UE spontaneously switches to the BWP indicated by the DCI BWP indicator.

When the measurement of the PRS processing window is completed, the UE reports the measurement result of the PRS processing window, and the measurement result is reported through PUSCH carrying positioning measurement report. The specific reporting method includes at least one of the following:
When the PRS processing window in the active DL BWP ends, PUSCH in the corresponding UL BWP is transmitted immediately, and the measurement result of the DL PRS resources is reported.
If the corresponding measurement result has been obtained in the first N time units of the PRS processing window in the active DL BWP, the PUSCH is transmitted from the time of the (N+1th) time unit to the time before the end of the PRS processing window, and the measurement result of the DL PRS resource is reported.
When multiple PRS processing windows in the active DL BWP end, the measurement result of the multiple PRS processing windows in the corresponding UL BWP is reported simultaneously through PUSCH.

The measurement result of the PRS processing window includes at least one or a combination of the following:
The received signal strength of the measurement path. The measurement path is defined as including but not limited to the first arrival path, the line-of-sight path, and the average or peak value of received signal strength of all the arrival paths within a certain period of time.
The downlink angle of departure for the measurement path. The measurement path is defined as including but not limited to the first arrival path, the line-of-sight path, and the paths received by different antenna connection points.
The time difference of received signals for the measurement path of the reference cell and the serving cell. The measurement path is defined as including but not limited
to the first arrival path, the line-of-sight path, and the strongest power path.
   UE Receiving and Transmitting time difference. The receiving time of UE is defined as including but not limited to the arrival time of the first arrival path, line-of-sight path, and the strongest power path, and the transmitting time is defined as the transmitting time of uplink signal of the UE which is closest to the downlink receiving time of the UE.

After the measurement result is reported, if the PRS processing window is configured by the UE, the UE spontaneously terminates the configured PRS processing window; and if the PRS processing window is configured by a base station device (such as NG-RAN) or a higher layer functional entity (such as LMF), after receiving the measurement report, the base station device (such as NG-RAN) or the higher layer functional entity (such as LMF) transmits an indication factor for terminating positioning measurement to the UE for terminating the configuration of the PRS processing window. The specific method is performed with at least one of the following:
The DCI signalling
The RRC signalling
The DL MAC CE
The NRPPa message
The LPP message

In another embodiment of the present invention, the UE performs the first operation when a first condition and/or a second condition is satisfied. The first condition can include a combination of one or more of the following:
According to the RRC indication signal, it is determined that the PRS is high priority and/or low priority and/or the PRS priority is lower than PDCCH and URLLC PDSCH and higher than other downlink channels and/or downlink signals (i.e. non-PRS, non-PDCCH, non-URLLC PDSCH, non-URLLC signals or channels). The URLLC channel corresponds a dynamically scheduled PDSCH whose PUCCH resource for carrying ACK/NAK is marked as high-priority. Optionally, the PRS priority information indicated by the RRC is not considered.
Subject to UE capabilities, the PRS is determined to be high priority;

The second condition can include a combination of one or more of the following:
The PRS processing window contains a second downlink signal, which includes at least one of the following: message 2 (MSG2), message B (MSGB) and the Search space of downlink physical downlink control channel (DL PDCCH) of message 4 (MSG4) during random access procedure, and/or physical downlink data channel containing random access response (RAR) in message 2 (MSG2 PDSCH), physical downlink data channel (PDSCH) of message B (MSGB) and physical downlink data channel (PDSCH) of message 4 (MSG4);
When the second downlink signal overlaps with the PRS (in whole or in part)
When the PRS overlaps with the second downlink signal (in whole or in part) with the time gap
The PRS processing window contains the first uplink signal, which includes at least one of the following: valid random access opportunity (valid RO) in random access procedure, message 3 (MSG3) physical uplink shared channel (PUSCH) (and/or retransmission of PUSCH), physical uplink control channel (PUCCH) corresponding to message 4 (MSG4), the transmission of PUCCH with high priority or low priority (and/or retransmission of PUCCH), and the transmission of PUSCH with high priority or low priority (and/or retransmission of PUSCH); and the sounding reference signal SRS;
When the first uplink signal overlaps with the PRS (in whole or in part)
When the PRS overlaps with the first uplink signal (in whole or in part) with the time gap
When the first uplink signal transmission with timing advance overlaps with the PRS (in whole or in part)
   The overlap includes the overlap in time domain and/or frequency domain.
   The PRS processing window can be an activated PRS processing window.

The first operation performed by the UE includes a combination of one or more of the following:
Expecting to receive the PRS;
Preferably, when PRS is determined as high priority;
Preferably, when PRS is determined as low priority and overlaps with low priority PUSCH (or any priority), the UE expects to receive the PRS, and the UE does not transmit PUSCH. This method can be based on the fact that the PRS in the PRS processing window is more important than PUSCH with the same priority, that is, the PRS is received preferentially;
Expecting to receive the second downlink signal;
Preferably, when the PRS is determined as high priority, and overlaps with PDSCH containing random access response (RAR) in random access procedure message 2 (MSG2), the UE does not receive the PRS, and the UE receives the PDSCH, to ensure the integrity of the random access process;
Expecting to transmit the first uplink signal;
Preferably, when PRS is determined as high priority, and overlaps with the high priority PUSCH, the UE does not receive PRS, and the UE transmits the high priority PUSCH to ensure the high priority characteristics of PUSCH;
Preferably, when PRS is determined as high priority, and overlaps with low priority (or any priority) PUCCH, the UE does not receive PRS, and the UE transmits PUCCH. This method is based on the fact that the importance of UCI is high; and even PUCCH with low priority should also be transmitted preferentially;
It is up to UE implementation to receive the PRS and/or receive the second downlink signal and/or transmit the first uplink signal;
Preferably, when the PRS has the equal priority as the second downlink signal and/or the first uplink signal, it is up to UE implementation to receive the PRS and/or receive the second downlink signal and/or transmit the first uplink signal.

FIG. 5 illustrates a structure of a UE according to an embodiment of the disclosure.

As shown in FIG. 5, the UE according to an embodiment may include a transceiver 510, a memory 520, and a processor 530. The transceiver 510, the memory 520, and the processor 530 of the UE may operate according to a communication method of the UE described above. However, the components of the UE are not limited thereto. For example, the UE may include more or fewer components than those described above. In addition, the processor 530, the transceiver 510, and the memory 520 may be implemented as a single chip. Also, the processor 530 may include at least one processor. Furthermore, the UE of FIG. 5 corresponds to the UE 116 of the FIG. 3A.

The transceiver 510 collectively refers to a UE receiver and a UE transmitter, and may transmit/receive a signal to/from a base station or a network entity. The signal transmitted or received to or from the base station or a network entity may include control information and data. The transceiver 510 may include a RF transmitter for up-converting and amplifying a frequency of a transmitted signal, and a RF receiver for amplifying low-noise and down-converting a frequency of a received signal. However, this is only an example of the transceiver 510 and components of the transceiver 510 are not limited to the RF transmitter and the RF receiver.

Also, the transceiver 510 may receive and output, to the processor 530, a signal through a wireless channel, and transmit a signal output from the processor 530 through the wireless channel.

The memory 520 may store a program and data required for operations of the UE. Also, the memory 520 may store control information or data included in a signal obtained by the UE. The memory 520 may be a storage medium, such as read-only memory (ROM), random access memory (RAM), a hard disk, a CD-ROM, and a DVD, or a combination of storage media.

The processor 530 may control a series of processes such that the UE operates as described above. For example, the transceiver 510 may receive a data signal including a control signal transmitted by the base station or the network entity, and the processor 530 may determine a result of receiving the control signal and the data signal transmitted by the base station or the network entity.

FIG. 6 illustrates a structure of a base station according to an embodiment of the disclosure.

As shown in FIG. 6, the base station according to an embodiment may include a transceiver 610, a memory 620, and a processor 630. The transceiver 610, the memory 620, and the processor 630 of the base station may operate according to a communication method of the base station described above. However, the components of the base station are not limited thereto. For example, the base station may include more or fewer components than those described above. In addition, the processor 630, the transceiver 610, and the memory 620 may be implemented as a single chip. Also, the processor 630 may include at least one processor. Furthermore, the base station of FIG. 6 corresponds to the gNB 102 of the FIG. 3B.

The transceiver 610 collectively refers to a base station receiver and a base station transmitter, and may transmit/receive a signal to/from a terminal (UE) or a network entity. The signal transmitted or received to or from the terminal or a network entity may include control information and data. The transceiver 610 may include a RF transmitter for up-converting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the processor 630, a signal through a wireless channel, and transmit a signal output from the processor 630 through the wireless channel.

The memory 620 may store a program and data required for operations of the base station. Also, the memory 620 may store control information or data included in a signal obtained by the base station. The memory 620 may be a storage medium, such as read-only memory (ROM), random access memory (RAM), a hard disk, a CD-ROM, and a DVD, or a combination of storage media.

The processor 630 may control a series of processes such that the base station operates as described above. For example, the transceiver 610 may receive a data signal including a control signal transmitted by the terminal, and the processor 630 may determine a result of receiving the control signal and the data signal transmitted by the terminal.

According to an embodiment of the present invention, there is also provided a method for positioning performed by a base station in a wireless communication system, which includes receiving measurement result of the signal for positioning from user equipment, wherein the measurement is performed in a window configured according to window configuration information of resources for configuring windows.

In one embodiment, a method is provided. The method includes receiving, from a base station, a configuration information of a downlink positioning reference signal processing window (DL PPW) via high layer signaling; measuring the signal for positioning within the DL PPW based on a priority of the signal for positioning; and transmitting, to the base station, a measurement result of the signal for positioning.

In one embodiment, the method further determining the priority of the signal for positioning in the DL PPW, wherein the priority of the signal for positioning is determined as at least one of the followings: indicated subject to UE capability, or implied by UE capability.

In one embodiment, wherein the priority of the signal for positioning is indicated as at least one of the followings: first value, when the signal for positioning is higher priority than other DL signals and channels except SSB, or second value, when the signal for positioning is lower priority than PDCCH and PDSCH scheduled by downlink control information (DCI), and is higher priority than other DL signals and channels except SSB, or third value, when the signal for positioning is lower than the other DL signals and channels except SSB.

In one embodiment, wherein the PRS is indicated as the second value, when the PRS is lower priority than PDCCH and ultra reliable low latency communication (URLLC) PDSCH, and is higher priority than other DL signals and channels except SSB.

In one embodiment, a method is provided. The method includes transmitting, to a user equipment (UE), a configuration information of a downlink positioning reference signal processing window (DL PPW) via high layer signaling; transmitting, to the UE, the signal for positioning based on the configuration information; and receiving, from the UE, a measurement result of the signal for positioning.

In one embodiment, wherein a priority of the signal for positioning is determined as at least one of the followings: indicated subject to UE capability, or implied by UE capability.

In one embodiment, wherein the priority of the signal for positioning is indicated as at least one of the followings: first value, when the signal for positioning is higher priority than other DL signals and channels except SSB, or second value, when the signal for positioning is lower priority than PDCCH and PDSCH scheduled by downlink control information (DCI), and is higher priority than other DL signals and channels except SSB, or third value, when the signal for positioning is lower than the other DL signals and channels except SSB.

In one embodiment, wherein the PRS is indicated as the second value, when the PRS is lower priority than PDCCH and ultra reliable low latency communication (URLLC) PDSCH, and is higher priority than other DL signals and channels except SSB.

In one embodiment, a UE is provided. The UE includes a transceiver; and at least one processor coupled with the transceiver and configured to: receive, from a base station, a configuration information of a downlink positioning reference signal processing window (DL PPW) via high layer signaling, measuring the signal for positioning within the DL PPW based on a priority of the signal for positioning; and transmit, to the base station, a measurement result of the signal for positioning.

In one embodiment, the UE further includes determine the priority of the signal for positioning in the DL PPW, wherein the priority of the signal for positioning is determined as at least one of the followings: indicated subject to UE capability, or implied by UE capability.

In one embodiment, wherein the priority of the signal for positioning is indicated as at least one of the followings: first value, when the signal for positioning is higher priority than other DL signals and channels except SSB, or second value, when the signal for positioning is lower priority than PDCCH and PDSCH scheduled by downlink control information (DCI), and is higher priority than other DL signals and channels except SSB, or third value, when the signal for positioning is lower than the other DL signals and channels except SSB.

In one embodiment, wherein the PRS is indicated as the second value, when the PRS is lower priority than PDCCH and ultra reliable low latency communication (URLLC) PDSCH, and is higher priority than other DL signals and channels except SSB.

In one embodiment, a base station is provided. The base station includes a transceiver; and at least one processor coupled with the transceiver and configured to: transmit, to a user equipment (UE), a configuration information of a downlink positioning reference signal processing window (DL PPW) via high layer signaling, transmit, to the UE, the signal for positioning based on the configuration information, and receive, from the UE, a measurement result of the signal for positioning.

In one embodiment, wherein a priority of the signal for positioning is determined as at least one of the followings: indicated subject to UE capability, or implied by UE capability.

In one embodiment, wherein the priority of the signal for positioning is indicated as at least one of the followings: first value, when the signal for positioning is higher priority than other DL signals and channels except SSB, or second value, when the signal for positioning is lower priority than PDCCH and PDSCH scheduled by downlink control information (DCI), and is higher priority than other DL signals and channels except SSB, or third value, when the signal for positioning is lower than the other DL signals and channels except SSB.

The disclosure also provides a computer-readable medium on which computer-executable instructions are stored, which, when executed, perform any of the methods described in the embodiments of the disclosure.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

The invention introduces a window specially used for the measurement of the positioning signal, and the measurement report can be completed under a lower time delay by configuring the window. As used herein, “user equipment” or “UE” can refer to any terminal with wireless communication capability, including but not limited to mobile phones, cellular phones, smart phones or personal digital assistants (PDA), portable computers, image capturing devices such as digital cameras, game devices, music storage and playback devices, and any portable unit or terminal with wireless communication capability, or Internet facilities that allow wireless Internet access and browsing, etc.

As used herein, the term “base station” (BS) or “network equipment” can refer to eNB, eNodeB, NodeB or base transceiver station (BTS), or gNB, etc. according to the used technology and terminology.

The “memory” here can be of any type suitable for the technical environment herein, and can be implemented using any suitable data storage technology, including but not limited to semiconductor-based memory devices, magnetic memory devices and systems, optical memory devices and systems, fixed memory and mobile storage.

The processor here can be any type suitable for the technical environment of this application, including but not limited to one or more of the followings: general-purpose computer, special-purpose computer, microprocessor, digital signal processor DSP and processor based on multi-core processor architecture.

The above description is only the preferred embodiment of the present invention, and it is not intended to limit the present invention. Any modification, equivalent replacement, improvement, etc. made within the spirit and principle of the present invention should be included in the scope of the present invention.

It can be understood by those skilled in the art that the present invention includes devices for performing one or more of the operations described in this application. These devices can be specially designed and manufactured for the required purposes, or they can also include known devices in general-purpose computers. These devices have stored therein computer programs that are selectively activated or reconfigured. Such a computer program can be stored in a device (e.g., computer) readable medium or in any type of medium suitable for storing electronic instructions and respectively coupled to a bus, including but not limited to any type of disk (including floppy disk, hard disk, optical disk, CD-ROM, and magneto-optical disk), ROM (Read-Only Memory), RAM (Random Access Memory), EPROM (erasable programmable read-only memory), EEPROM (electrically erasable programmable read-only memory), flash memory, magnetic card or optical card. That is, a readable medium includes any medium that stores or transmits information in a readable form by a device (e.g., a computer).

It can be understood by those skilled in the art that each block in these structural diagrams and/or block diagrams and/or flow diagrams and combinations of blocks in these structural diagrams and/or block diagrams and/or flow diagrams can be implemented by computer program instructions. Those skilled in the art can understand that these computer program instructions can be provided to a processor of a general-purpose computer, a professional computer or other programmable data processing methods for implementation, so that the scheme specified in the block or blocks of the structure diagram and/or block diagram and/or flow diagram disclosed by the present invention can be executed by the processor of the computer or other programmable data processing methods.

Those skilled in the art can understand that the steps, measures and schemes in various operations, methods and processes already discussed in the present invention can be alternated, changed, combined or deleted. Furthermore, other steps, measures and schemes having the various operations, methods and processes already discussed in the present invention can also be alternated, changed, rearranged, decomposed, combined or deleted. Furthermore, the steps, measures and schemes in various operations, methods and processes disclosed in the prior art can also be alternated, changed, rearranged, decomposed, combined or deleted.

The above is only a partial embodiment of the present invention. It should be pointed out that for those skilled in the art, without departing from the principle of the present invention, several improvements and embellishments can be made, which should also be regarded as the protection scope of the present invention.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

1. A method performed by a user equipment (UE) in a wireless communication system, the method comprising:
receiving, from a base station, configuration information for a downlink (DL) positioning reference signal (PRS) processing window (DL PPW);
identifying whether a priority of a DL PRS is higher than a priority of at least one of another downlink signal or downlink channel, based on the configuration information;
measuring the DL PRS within the DL PPW, in case that the priority of the DL PRS is higher than the priority of at least one of the other downlink signal or the downlink channel; and
transmitting, to the base station, a report related to the measurement.

2. The method of claim 1, wherein the priority of the DL PRS is identified based on the configuration information, which is subject to a UE capability.

3. The method of claim 1, wherein a bandwidth part (BWP) switching is not occurred within the DL PPW.

4. The method of claim 1, wherein the DL PRS is measured outside a measurement gap and within the DL PPW.

5. A method performed by a base station in a wireless communication system, the method comprising:
transmitting, to a user equipment (UE), configuration information for a downlink (DL) positioning reference signal (PRS) processing window (DL PPW); and
receiving, from the UE, a report related to a measurement of the DL PRS, wherein the measurement of the DL PRS is within the DL PPW and is based on the configuration information,
wherein a priority of the DL PRS is higher than a priority of at least one of another downlink signal or downlink channel.

6. The method of claim 5, wherein a priority of the DL PRS is based on the configuration information, which is subject to a UE capability.

7. The method of claim 5, wherein a bandwidth part, BWP, switching is not occurred within the DL PPW.

8. The method of claim 5, wherein the measurement is outside a measurement gap and within the DL PPW.

9. A user equipment (UE) in wireless communication system, the UE comprising:
a transceiver; and
at least one processor coupled with the transceiver and configured to:
receive, from a base station, configuration information for a downlink (DL) positioning reference signal (PRS) processing window (DL PPW); and
identify whether a priority of a DL PRS is higher than a priority of the at least one of other downlink signal or downlink channel, based on the configuration information,
measure the DL PRS within the DL PPW, in case that the priority of the DL PRS is higher than the priority of at least one of the other downlink signal or the downlink channel; and
transmitting, to the base station, a report related to the measurement.

10. The UE of claim 9, wherein the priority of the DL PRS is identified based on the configuration information, which is subject to a UE capability.

11. The UE of claim 9, wherein a bandwidth part, BWP, switching is not occurred within the DL PPW.

12. The UE of claim 9, wherein the DL PRS is measured outside a measurement gap and within the DL PPW.

13. A base station in wireless communication system, the base station comprising:
a transceiver; and
at least one processor coupled with the transceiver and configured to:
transmit, to a user equipment (UE), configuration information for a downlink (DL) positioning reference signal (PRS) processing window (DL PPW), and
receive, from the UE, a report related to a measurement of the DL PRS, wherein the measurement of the DL PRS is within the DL PPW and is based on the configuration information,
wherein a priority of the DL PRS is higher than a priority of at least one of other downlink signal or downlink channel.

14. The base station of claim 13, wherein a priority of the DL PRS is based on the configuration information, which is subject to a UE capability.

15. The base station of claim 13, wherein a bandwidth part, BWP, switching is not occurred within the DL PPW.

16. The base station of claim 13, wherein the measurement is outside a measurement gap and within the DL PPW.

17. The method of claim 1, wherein the priority of the DL PRS is implied by a UE capability.

18. The method of claim 5, wherein the priority of the DL PRS is implied by a UE capability.

19. The UE of claim 9, wherein the priority of the DL PRS is implied by a UE capability.

20. The base station of claim 13, wherein the priority of the DL PRS is implied by a UE capability.
